(19) United States
(12) Patent Application Publication
(10) Pub. No.: US 2025/0047690 A1
(43) Pub. Date: Feb. 6, 2025

(54) SECURITY MANAGEMENT FOR ENDPOINT NODES OF DISTRIBUTED PROCESSING SYSTEMS

(71) Applicant: Dell Products L.P., Round Rock, TX (US)

(72) Inventors: Pramod Kumar Puthanveettil Kurungodan, Bengaluru (IN); Peniel Charles, Bangalore (IN); Manikandan Sethuraman, Bangalore (IN)

(21) Appl. No.: 18/363,884

(22) Filed: Aug. 2, 2023

(51) Int. Cl. H04L 9/40; H04L 67/1008

(52) U.S. Cl. CPC H04L 63/1416; H04L 63/1433; H04L 67/1008

(57) ABSTRACT

An apparatus includes at least one processing device configured to determine, for endpoint nodes of a distributed processing system, node security information characterizing security issues encountered on one or more of the endpoint nodes. The processing device is also configured to identify, based on the node security information, a first type of security issues encountered on a first endpoint node and a second type of security issues encountered on a second endpoint node. The processing device is further configured to select first and second sets of corrective actions for the first and second types of security issues. The processing device is further configured to apply, to the first endpoint node, the first set of corrective actions, and to apply the second set of corrective actions by deploying an additional endpoint node in the distributed processing system and migrating workloads running on the second endpoint node to the additional endpoint node.

### BACKGROUND

Information processing systems often include distributed arrangements of multiple nodes, also referred to herein as distributed processing systems. Such systems can include, for example, distributed storage systems comprising multiple storage nodes. These distributed storage systems are often dynamically reconfigurable under software control in order to adapt the number and type of storage nodes and the corresponding system storage capacity as needed, in an arrangement commonly referred to as a software-defined storage system. For example, in a typical software-defined storage system, storage capacities of multiple distributed storage nodes are pooled together into one or more storage pools. Data within the system is partitioned, striped, and replicated across the distributed storage nodes. For a storage administrator, the software-defined storage system provides a logical view of a given dynamic storage pool that can be expanded or contracted at ease, with simplicity, flexibility, and different performance characteristics. For applications running on a host device that utilizes the software-defined storage system, such a storage system provides a logical storage object view to allow a given application to store and access data, without the application being aware that the data is being dynamically distributed among different storage nodes potentially at different sites.

### SUMMARY

Illustrative embodiments disclosed herein provide techniques for security management for endpoint nodes of distributed processing systems. Such endpoint nodes in some embodiments can comprise, for example, respective compute nodes of a distributed processing system. Additionally or alternatively, such endpoint nodes in some embodiments can comprise, for example, respective storage nodes of a distributed storage system. A distributed storage system is therefore considered a type of distributed processing system as that latter term is broadly used herein.

In one embodiment, an apparatus comprises at least one processing device that includes a processor coupled to a memory. The at least one processing device is configured to determine, for a plurality of endpoint nodes of a distributed processing system, node security information characterizing one or more security issues encountered on one or more of the plurality of endpoint nodes of the distributed processing system. The at least one processing device is also configured to identify, based at least in part on the determined node security information, a first type of the one or more security issues encountered on at least a first one of the plurality of endpoint nodes of the distributed processing system and a second type of the one or more security issues encountered on at least a second one of the plurality of endpoint nodes of the distributed processing system. The at least one processing device is further configured to select a first set of one or more corrective actions for the first type of the one or more security issues and a second set of one or more corrective actions for the second type of the one or more security issues. The at least one processing device is further configured to apply, to the first endpoint node, the first set of one or more corrective actions, and to apply the second set of one or more corrective actions by deploying at least one additional endpoint node in the distributed processing system and migrating one or more workloads running on the second endpoint node to the at least one additional endpoint node.

These and other illustrative embodiments include, without limitation, apparatus, systems, methods and processor-readable storage media.

### BRIEF DESCRIPTION OF THE DRAWINGS

FIG. 1 is a block diagram of an information processing system incorporating functionality for security management for endpoint nodes of distributed processing systems in an illustrative embodiment.

FIG. 2 is a flow diagram of a process for security management for endpoint nodes of distributed processing systems in an illustrative embodiment.

FIG. 3 shows an example of an information processing system incorporating functionality for security management in a software-defined storage system in an illustrative embodiment.

FIG. 4 shows an example of an information processing system incorporating functionality for security management in a multi-cloud distributed system in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

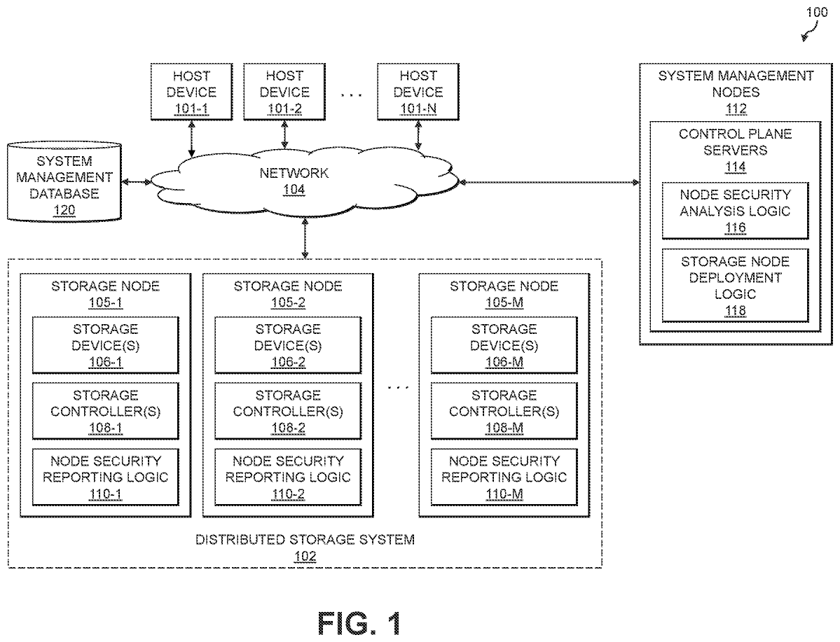

FIG. 1 shows an information processing system 100 configured in accordance with an illustrative embodiment. The information processing system 100 comprises a plurality of host devices 101-1, 101-2 . . . 101-N, collectively referred to herein as host devices 101, and a distributed storage system 102 shared by the host devices 101. The distributed storage system 102 is an example of what is more generally referred to herein as a distributed processing system, which may include a combination of one or more compute and storage nodes. The host devices 101 and distributed storage system 102 in this embodiment are configured to communicate with one another via a network 104 that illustratively utilizes protocols such as Transmission Control Protocol (TCP) and/or Internet Protocol (IP), and may therefore be referred to herein as a TCP/IP network, although it is to be appreciated that the network 104 can operate using additional or alternative protocols. In some embodiments, the network 104 comprises a storage area network (SAN) that includes one or more Fibre Channel (FC) switches, Ethernet switches or other types of switch fabrics.

The distributed storage system 102 more particularly comprises a plurality of storage nodes 105-1, 105-2, . . . 105-M, collectively referred to herein as storage nodes 105. The values N and M in this embodiment denote arbitrary integer values that in the figure are illustrated as being greater than or equal to three, although other values such as N=1, N=2, M=1 or M=2 can be used in other embodiments.

The storage nodes 105 collectively form the distributed storage system 102, which is just one possible example of what is generally referred to herein as a “distributed storage system.” Other distributed storage systems can include different numbers and arrangements of storage nodes, and possibly one or more additional components. For example, as indicated above, a distributed storage system in some embodiments may include only first and second storage nodes, corresponding to an M=2 embodiment. Some embodiments can configure a distributed storage system to include additional components in the form of a system manager implemented using one or more additional nodes.

In some embodiments, the distributed storage system 102 provides a logical address space that is divided among the storage nodes 105, such that different ones of the storage nodes 105 store the data for respective different portions of the logical address space. Accordingly, in these and other similar distributed storage system arrangements, different ones of the storage nodes 105 have responsibility for different portions of the logical address space. For a given logical storage volume, logical blocks of that logical storage volume are illustratively distributed across the storage nodes 105.

Other types of distributed storage systems can be used in other embodiments. For example, distributed storage system 102 can comprise multiple distinct storage arrays, such as a production storage array and a backup storage array, possibly deployed at different locations. Accordingly, in some embodiments, one or more of the storage nodes 105 may each be viewed as comprising at least a portion of a separate storage array with its own logical address space. Alternatively, the storage nodes 105 can be viewed as collectively comprising one or more storage arrays. The term “storage node” as used herein is therefore intended to be broadly construed.

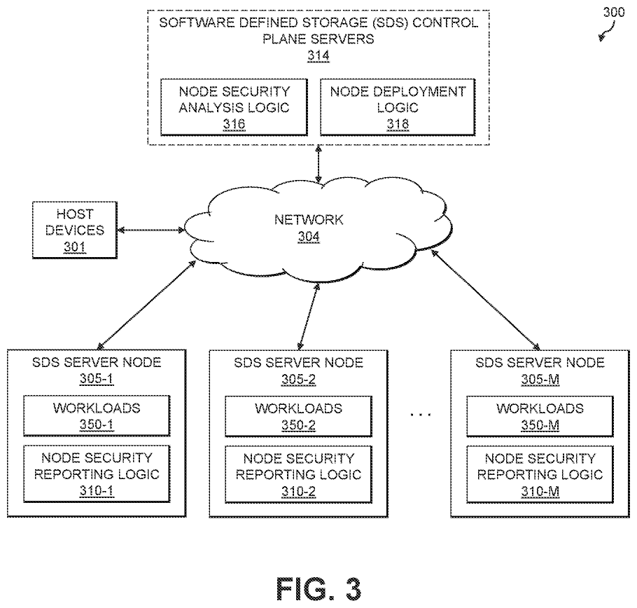

In some embodiments, the distributed storage system 102 comprises a software-defined storage system and the storage nodes 105 comprise respective software-defined storage server nodes of the software-defined storage system, such nodes also being referred to herein as SDS server nodes, where SDS denotes software-defined storage. Accordingly, the number and types of storage nodes 105 can be dynamically expanded or contracted under software control in some embodiments. Examples of such software-defined storage systems will be described in more detail below in conjunction with FIG. 3.

Each of the storage nodes 105 is illustratively configured to interact with one or more of the host devices 101. The host devices 101 illustratively comprise servers or other types of computers of an enterprise computer system, cloud-based computer system or other arrangement of multiple compute nodes associated with respective users.

The host devices 101 in some embodiments illustratively provide compute services such as execution of one or more applications on behalf of each of one or more users associated with respective ones of the host devices 101. Such applications illustratively generate input-output (IO) operations that are processed by a corresponding one of the storage nodes 105. The term “input-output” as used herein refers to at least one of input and output. For example, IO operations may comprise write requests and/or read requests directed to logical addresses of a particular logical storage volume of one or more of the storage nodes 105. These and other types of IO operations are also generally referred to herein as IO requests.

The IO operations that are currently being processed in the distributed storage system 102 in some embodiments are referred to herein as “in-flight” IOs that have been admitted by the storage nodes 105 to further processing within the system 100. The storage nodes 105 are illustratively configured to queue IO operations arriving from one or more of the host devices 101 in one or more sets of IO queues.

The storage nodes 105 illustratively comprise respective processing devices of one or more processing platforms. For example, the storage nodes 105 can each comprise one or more processing devices each having a processor and a memory, possibly implementing virtual machines and/or containers, although numerous other configurations are possible.

The storage nodes 105 can additionally or alternatively be part of cloud infrastructure, such as a cloud-based system implementing Storage-as-a-Service (STaaS) functionality.

The storage nodes 105 may be implemented on a common processing platform, or on separate processing platforms.

The host devices 101 are illustratively configured to write data to and read data from the distributed storage system 102 comprising storage nodes 105 in accordance with applications executing on those host devices 101 for system users.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise. Combinations of cloud and edge infrastructure can also be used in implementing a given information processing system to provide services to users.

Communications between the components of system 100 can take place over additional or alternative networks, including a global computer network such as the Internet, a wide area network (WAN), a local area network (LAN), a satellite network, a telephone or cable network, a cellular network such as 4G or 5G cellular network, a wireless network such as a WiFi or WiMAX network, or various portions or combinations of these and other types of networks. The system 100 in some embodiments therefore comprises one or more additional networks other than network 104 each comprising processing devices configured to communicate using TCP, IP and/or other communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand or Gigabit Ethernet, in addition to or in place of FC. Numerous alternative networking arrangements are possible in a given embodiment, as will be appreciated by those skilled in the art. Other examples include remote direct memory access (RDMA) over Converged Ethernet (ROCE) or InfiniBand over Ethernet (IBoE).

The first storage node 105-1 comprises a plurality of storage devices 106-1 and one or more associated storage controllers 108-1. The storage devices 106-1 illustratively store metadata pages and user data pages associated with one or more storage volumes of the distributed storage system 102. The storage volumes illustratively comprise respective logical units (LUNs) or other types of logical storage volumes. The storage devices 106-1 more particularly comprise local persistent storage devices of the first storage node 105-1. Such persistent storage devices are local to the first storage node 105-1, but remote from the second storage node 105-2, the storage node 105-M and any other ones of other storage nodes 105.

Each of the other storage nodes 105-2 through 105-M is assumed to be configured in a manner similar to that described above for the first storage node 105-1. Accordingly, by way of example, storage node 105-2 comprises a plurality of storage devices 106-2 and one or more associated storage controllers 108-2, and storage node 105-M comprises a plurality of storage devices 106-M and one or more associated storage controllers 108-M.

As indicated previously, the storage devices 106-2 through 106-M illustratively store metadata pages and user data pages associated with one or more storage volumes of the distributed storage system 102, such as the above-noted LUNs or other types of logical storage volumes. The storage devices 106-2 more particularly comprise local persistent storage devices of the storage node 105-2. Such persistent storage devices are local to the storage node 105-2, but remote from the first storage node 105-1, the storage node 105-M, and any other ones of the storage nodes 105. Similarly, the storage devices 106-M more particularly comprise local persistent storage devices of the storage node 105-M. Such persistent storage devices are local to the storage node 105-M, but remote from the first storage node 105-1, the second storage node 105-2, and any other ones of the storage nodes 105.

The local persistent storage of a given one of the storage nodes 105 illustratively comprises the particular local persistent storage devices that are implemented in or otherwise associated with that storage node. It is assumed that such local persistent storage devices of the given storage node are accessible to the storage controllers of that node via a local interface, and are accessible to storage controllers 108 of respective other ones of the storage nodes 105 via remote interfaces. For example, it is assumed in some embodiments disclosed herein that each of the storage devices 106 on a given one of the storage nodes 105 can be accessed by the given storage node via its local interface, or by any of the other storage nodes 105 via an RDMA interface. A given storage application executing on the storage nodes 105 illustratively requires that all of the storage nodes 105 be able to access all of the storage devices 106. Such access to local persistent storage of each node from the other storage nodes can be performed, for example, using the RDMA interfaces with the other storage nodes, although numerous other arrangements are possible.

The storage controllers 108 of the storage nodes 105 may include additional modules and other components typically found in conventional implementations of storage controllers and storage systems, although such additional modules and other components are omitted from the figure for clarity and simplicity of illustration.

For example, the storage controllers 108 can comprise or be otherwise associated with one or more write caches and one or more write cache journals, both also illustratively distributed across the storage nodes 105 of the distributed storage system. It is further assumed in illustrative embodiments that one or more additional journals are provided in the distributed storage system, such as, for example, a metadata update journal and possibly other journals providing other types of journaling functionality for IO operations. Illustrative embodiments disclosed herein are assumed to be configured to perform various destaging processes for write caches and associated journals, and to perform additional or alternative functions in conjunction with processing of IO operations.

The storage devices 106 of the storage nodes 105 illustratively comprise solid state drives (SSDs). Such SSDs are implemented using non-volatile memory (NVM) devices such as flash memory. Other types of NVM devices that can be used to implement at least a portion of the storage devices 106 include non-volatile random access memory (NVRAM), phase-change RAM (PC-RAM), magnetic RAM (MRAM), resistive RAM, spin torque transfer magneto-resistive RAM (STT-MRAM), and Intel Optane™ devices based on 3D XPoint™ memory. These and various combinations of multiple different types of NVM devices may also be used. For example, hard disk drives (HDDs) can be used in combination with or in place of SSDs or other types of NVM devices.

However, it is to be appreciated that other types of storage devices can be used in other embodiments. For example, a given storage system as the term is broadly used herein can include a combination of different types of storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices. Such storage devices are examples of storage devices 106 of the storage nodes 105 of the distributed storage system 102 of FIG. 1.

In some embodiments, the storage nodes 105 of the distributed storage system 102 collectively provide a scale-out storage system, although the storage nodes 105 can be used to implement other types of storage systems in other embodiments. One or more such storage nodes can be associated with at least one storage array. Additional or alternative types of storage products that can be used in implementing a given storage system in illustrative embodiments include software-defined storage, cloud storage and object-based storage. Combinations of multiple ones of these and other storage types can also be used.

As indicated above, the storage nodes 105 in some embodiments comprise respective software-defined storage server nodes of a software-defined storage system, in which the number and types of storage nodes 105 can be dynamically expanded or contracted under software control using software-defined storage techniques.

The term “storage system” as used herein is therefore intended to be broadly construed, and should not be viewed as being limited to certain types of storage systems, such as content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

In some embodiments, communications between the host devices 101 and the storage nodes 105 comprise NVMe commands of an NVMe storage access protocol, for example, as described in the NVMe Specification, Revision 2.0a, July 2021, which is incorporated by reference herein. Other examples of NVMe storage access protocols that may be utilized in illustrative embodiments disclosed herein include NVMe over Fabrics, also referred to herein as NVMeF, and NVMe over TCP, also referred to herein as NVMe/TCP. Other embodiments can utilize other types of storage access protocols. As another example, communications between the host devices 101 and the storage nodes 105 in some embodiments can comprise Small Computer System Interface (SCSI) or Internet SCSI (iSCSI) commands.

Other types of commands may be used in other embodiments, including commands that are part of a standard command set, or custom commands such as a “vendor unique command” or VU command that is not part of a standard command set. The term “command” as used herein is therefore intended to be broadly construed, so as to encompass, for example, a composite command that comprises a combination of multiple individual commands. Numerous other types, formats and configurations of IO operations can be used in other embodiments, as that term is broadly used herein.

Some embodiments disclosed herein are configured to utilize one or more RAID arrangements to store data across the storage devices 106 in each of one or more of the storage nodes 105 of the distributed storage system 102.

The RAID arrangement can comprise, for example, a RAID 5 arrangement supporting recovery from a failure of a single one of the plurality of storage devices, a RAID 6 arrangement supporting recovery from simultaneous failure of up to two of the storage devices, or another type of RAID arrangement. For example, some embodiments can utilize RAID arrangements with redundancy higher than two.

The term “RAID arrangement” as used herein is intended to be broadly construed, and should not be viewed as limited to RAID 5, RAID 6 or other parity RAID arrangements. For example, a RAID arrangement in some embodiments can comprise combinations of multiple instances of distinct RAID approaches, such as a mixture of multiple distinct RAID types (e.g., RAID 1 and RAID 6) over the same set of storage devices, or a mixture of multiple stripe sets of different instances of one RAID type (e.g., two separate instances of RAID 5) over the same set of storage devices. Other types of parity RAID techniques and/or non-parity RAID techniques can be used in other embodiments.

Such a RAID arrangement is illustratively established by the storage controllers 108 of the respective storage nodes 105. The storage devices 106 in the context of RAID arrangements herein are also referred to as “disks” or “drives.” A given such RAID arrangement may also be referred to in some embodiments herein as a “RAID array.”

The RAID arrangement used in an illustrative embodiment includes an array of n different “disks” denoted 1 through n, each a different physical storage device of the storage devices 106. Multiple such physical storage devices are typically utilized to store data of a given LUN or other logical storage volume in the distributed storage system. For example, data pages or other data blocks of a given LUN or other logical storage volume can be “striped” along with its corresponding parity information across multiple ones of the disks in the RAID arrangement in accordance with RAID 5 or RAID 6 techniques.

A given RAID 5 arrangement defines block-level striping with single distributed parity and provides fault tolerance of a single drive failure, so that the array continues to operate with a single failed drive, irrespective of which drive fails. For example, in a conventional RAID 5 arrangement, each stripe includes multiple data blocks as well as a corresponding p parity block. The p parity blocks are associated with respective row parity information computed using well-known RAID 5 techniques. The data and parity blocks are distributed over the disks to support the above-noted single distributed parity and its associated fault tolerance.

A given RAID 6 arrangement defines block-level striping with double distributed parity and provides fault tolerance of up to two drive failures, so that the array continues to operate with up to two failed drives, irrespective of which two drives fail. For example, in a conventional RAID 6 arrangement, each stripe includes multiple data blocks as well as corresponding p and q parity blocks. The p and q parity blocks are associated with respective row parity information and diagonal parity information computed using well-known RAID 6 techniques. The data and parity blocks are distributed over the disks to collectively provide a diagonal-based configuration for the p and q parity information, so as to support the above-noted double distributed parity and its associated fault tolerance.

In such RAID arrangements, the parity blocks are typically not read unless needed for a rebuild process triggered by one or more storage device failures.

These and other references herein to RAID 5, RAID 6 and other particular RAID arrangements are only examples, and numerous other RAID arrangements can be used in other embodiments. Also, other embodiments can store data across the storage devices 106 of the storage nodes 105 without using RAID arrangements.

In some embodiments, the storage nodes 105 of the distributed storage system 102 of FIG. 1 are connected to each other in a full mesh network, and are collectively managed by a system manager. A given set of storage devices 106 on a given one of the storage nodes 105 is illustratively implemented in a disk array enclosure (DAE) or other type of storage array enclosure of that storage node. Each of the storage nodes 105 illustratively comprises a CPU or other type of processor, a memory, a network interface card (NIC) or other type of network interface, and its corresponding storage devices 106, possibly arranged as part of a DAE of the storage node.

In some embodiments, different ones of the storage nodes 105 are associated with the same DAE or other type of storage array enclosure. The system manager is illustratively implemented as a management module or other similar management logic instance, possibly running on one or more of the storage nodes 105, on another storage node and/or on a separate non-storage node of the distributed storage system.

As a more particular non-limiting illustration, the storage nodes 105 in some embodiments are paired together in an arrangement referred to as a “brick,” with each such brick being coupled to a different DAE comprising multiple drives, and each node in a brick being connected to the DAE and to each drive through a separate connection. The system manager may be running on one of the two nodes of a first one of the bricks of the distributed storage system. Again, numerous other arrangements of the storage nodes are possible in a given distributed storage system as disclosed herein.

The system 100 as shown further comprises a plurality of system management nodes 112 that are illustratively configured to provide system management functionality of the type noted above. Such functionality in the present embodiment illustratively further involves utilization of control plane servers 114 and a system management database 120. In some embodiments, at least portions of the system management nodes 112 and their associated control plane servers 114 are distributed over the storage nodes 105. For example, a designated subset of the storage nodes 105 can each be configured to include a corresponding one of the control plane servers 114. Other system management functionality provided by system management nodes 112 can be similarly distributed over a subset of the storage nodes 105.

The system management database 120 stores configuration and operation information of the system 100 and portions thereof are illustratively accessible to various system administrators such as host administrators and storage administrators. In some embodiments, the system management database 120 stores information related to node health of the storage nodes 105, such as node security information (e.g., information related to security alerts raised on one or more of the storage nodes 105).

In some embodiments, IO operations are processed in the host devices utilizing respective instances of path selection logic in the following manner. A given one of the host devices 101 establishes a plurality of paths between at least one initiator of the given host device and a plurality of targets of respective storage nodes 105 of the distributed storage system 102. Accordingly, the given host device illustratively comprises a plurality of initiators and supports one or more paths between each of the initiators and one or more targets on respective ones of the storage nodes 105.

For each of a plurality of IO operations generated in the given host device for delivery to the distributed storage system 102, the host device determines a particular portion of the logical storage volume to which the IO operation is directed, and identifies, based at least in part on stored locality information, which of the storage nodes 105 of the distributed storage system 102 stores the particular portion of the logical storage volume. The given host device then selects a path to the identified storage node, and sends the IO operation to the identified storage node over the selected path.

It is to be appreciated that host-based locality determination and associated path selection as disclosed herein can be performed independently by each of the host devices 101, illustratively utilizing their respective instances of path selection logic, as indicated above, with possible involvement of additional or alternative system components, such as locality processing logic. Such logic instances can be implemented within or otherwise in association with one or more multi-path drivers of the host devices 101.

In some embodiments, the initiator of the given host device and the targets of the respective storage nodes 105 are configured to support a designated standard storage access protocol, such as an NVMe storage access protocol or a SCSI storage access protocol. As more particularly examples in the NVMe context, the designated storage access protocol may comprise an NVMeF or NVMe/TCP storage access protocol, although a wide variety of additional or alternative storage access protocols can be used in other embodiments.

As mentioned above, the distributed storage system 102 in some embodiments comprises a software-defined storage system and the storage nodes 105 comprise respective software-defined storage server nodes of the software-defined storage system. An example of such a software-defined storage system will be described in more detail below in conjunction with the illustrative embodiment of FIG. 3.

In some embodiments, the given host device is configured to select paths for delivery of IO operations to the storage nodes 105 based at least in part on stored locality information, in a manner that ensures that the IO operations are directly delivered to the particular storage nodes 105 that locally store the corresponding targeted portions of the logical storage volume. Different mappings or other types and arrangements of locality information are illustratively stored by the given host device for different LUNs or other logical storage volumes that are accessed by the given host device.

The host devices 101 can comprise additional or alternative components. For example, in some embodiments, the host devices 101 further comprise respective sets of IO queues and respective multi-path input-output (MPIO) drivers. The MPIO drivers collectively comprise a multi-path layer of the host devices 101. Path selection functionality for delivery of IO operations from the host devices 101 to the distributed storage system 102 is provided in the multi-path layer by respective instances of path selection logic associated with the MPIO drivers. In some embodiments, the instances of path selection logic are implemented at least in part within the MPIO drivers of the host devices 101.

The MPIO drivers may comprise, for example, otherwise conventional MPIO drivers, such as PowerPath® drivers from Dell Technologies, suitably modified in the manner disclosed herein to provide functionality for host-based locality determination and associated path selection based at least in part on stored locality information. Other types of MPIO drivers from other driver vendors may be suitably modified to incorporate functionality for host-based locality determination and associated path selection as disclosed herein.

In some embodiments, the instances of path selection logic include or are otherwise associated with locality processing logic that is configured to obtain the locality information from the storage nodes 105. These and other aspects of locality determination functionality may illustratively be implemented within the MPIO drivers of respective host devices 101.

In some embodiments, the host devices 101 comprise respective local caches, implemented using respective memories of those host devices. A given such local cache can be implemented using one or more cache cards. A wide variety of different caching techniques can be used in other embodiments, as will be appreciated by those skilled in the art. Other examples of memories of the respective host devices 101 that may be utilized to provide local caches include one or more memory cards or other memory devices, such as, for example, an NVMe over PCIe cache card, a local flash drive or other type of NVM storage drive, or combinations of these and other host memory devices.

The MPIO drivers are illustratively configured to deliver IO operations selected from their respective sets of IO queues to the distributed storage system 102 via selected ones of multiple paths over the network 104. The sources of the IO operations stored in the sets of IO queues illustratively include respective processes of one or more applications executing on the host devices 101. For example, IO operations can be generated by each of multiple processes of a database application running on one or more of the host devices 101. Such processes issue IO operations for delivery to the distributed storage system 102 over the network 104. Other types of sources of IO operations may be present in a given implementation of system 100.

A given IO operation is therefore illustratively generated by a process of an application running on a given one of the host devices 101, and is queued in one of the IO queues of the given host device with other operations generated by other processes of that application, and possibly other processes of other applications.

The paths from the given host device to the distributed storage system 102 illustratively comprise paths associated with respective initiator-target pairs, with each initiator comprising a host bus adaptor (HBA) or other initiating entity of the given host device and each target comprising a port or other targeted entity corresponding to one or more of the storage devices 106 of the distributed storage system 102. As noted above, the storage devices 106 illustratively comprise LUNs or other types of logical storage devices, including logical storage devices also referred to herein as logical storage volumes.

In some embodiments, the paths are associated with respective communication links between the given host device and the distributed storage system 102 with each such communication link having a negotiated link speed. For example, in conjunction with registration of a given HBA to a switch of the network 104, the HBA and the switch may negotiate a link speed. The actual link speed that can be achieved in practice in some cases is less than the negotiated link speed, which is a theoretical maximum value.

Negotiated rates of the respective particular initiator and the corresponding target illustratively comprise respective negotiated data rates determined by execution of at least one link negotiation protocol for an associated one of the paths.

In some embodiments, at least a portion of the initiators comprise virtual initiators, such as, for example, respective ones of a plurality of N-Port ID Virtualization (NPIV) initiators associated with one or more Fibre Channel (FC) network connections. Such initiators illustratively utilize NVMe arrangements such as NVMe/FC, although other protocols can be used. Other embodiments can utilize other types of virtual initiators in which multiple network addresses can be supported by a single network interface, such as, for example, multiple media access control (MAC) addresses on a single network interface of an Ethernet network interface card (NIC). Accordingly, in some embodiments, the multiple virtual initiators are identified by respective ones of a plurality of media MAC addresses of a single network interface of a NIC. Such initiators illustratively utilize NVMe arrangements such as NVMe/TCP, although again other protocols can be used. In some embodiments, the NPIV feature of FC allows a single host HBA port to expose multiple World Wide Numbers (WWNs) or other types of identifiers to the network 104 and the distributed storage system 102.

Accordingly, in some embodiments, multiple virtual initiators are associated with a single HBA of a given one of the host devices 101 but have respective unique identifiers associated therewith.

Additionally or alternatively, different ones of the multiple virtual initiators are illustratively associated with respective different ones of a plurality of virtual machines of the given host device that share a single HBA of the given host device, or a plurality of logical partitions of the given host device that share a single HBA of the given host device.

Again, numerous alternative virtual initiator arrangements are possible, as will be apparent to those skilled in the art. The term “virtual initiator” as used herein is therefore intended to be broadly construed. It is also to be appreciated that other embodiments need not utilize any virtual initiators. References herein to the term “initiators” are intended to be broadly construed, and should therefore be understood to encompass physical initiators, virtual initiators, or combinations of both physical and virtual initiators.

Various scheduling algorithms, load balancing algorithms and/or other types of algorithms can be utilized by the MPIO driver of the given host device in delivering IO operations from the IO queues of that host device to the distributed storage system 102 over particular paths via the network 104. Each such IO operation is assumed to comprise one or more commands for instructing the distributed storage system 102 to perform particular types of storage-related functions such as reading data from or writing data to particular logical volumes of the distributed storage system 102. Such commands are assumed to have various payload sizes associated therewith, and the payload associated with a given command is referred to herein as its “command payload.”

A command directed by the given host device to the distributed storage system 102 is considered an “outstanding” command until such time as its execution is completed in the viewpoint of the given host device, at which time it is considered a “completed” command. The commands illustratively comprise respective NVMe commands, although other command formats, such as SCSI command formats, can be used in other embodiments. In the SCSI context, a given such command is illustratively defined by a corresponding command descriptor block (CDB) or similar format construct. The given command can have multiple blocks of payload associated therewith, such as a particular number of 512-byte SCSI blocks or other types of blocks. Other command formats are utilized in the NVMe context.

In illustrative embodiments to be described below, it is assumed without limitation that the initiators of a plurality of initiator-target pairs comprise respective HBAs of the given host device and that the targets of the plurality of initiator-target pairs comprise respective ports of the distributed storage system 102. A wide variety of other types and arrangements of initiators and targets can be used in other embodiments.

Selecting a particular one of multiple available paths for delivery of a selected one of the IO operations from the given host device is more generally referred to herein as “path selection.” Path selection as that term is broadly used herein can in some cases involve both selection of a particular IO operation and selection of one of multiple possible paths for accessing a corresponding logical device of the distributed storage system 102. The corresponding logical device illustratively comprises a LUN or other logical storage volume to which the particular IO operation is directed.

It should be noted that paths may be added or deleted between the host devices 101 and the distributed storage system 102 in the system 100. For example, the addition of one or more new paths from the given host device to the distributed storage system 102 or the deletion of one or more existing paths from the given host device to the distributed storage system 102 may result from respective addition or deletion of at least a portion of the storage devices 106 of the distributed storage system 102.

Addition or deletion of paths can also occur as a result of zoning and masking changes or other types of storage system reconfigurations performed by a storage administrator or other user. Some embodiments are configured to send a predetermined command from the given host device to the distributed storage system 102, illustratively utilizing the MPIO driver, to determine if zoning and masking information has been changed. The predetermined command can comprise, for example, a log sense command, a mode sense command, a “vendor unique command” or VU command, or combinations of multiple instances of these or other commands, in an otherwise standardized command format.

In some embodiments, paths are added or deleted in conjunction with addition of a new storage array or deletion of an existing storage array from a storage system that includes multiple storage arrays, possibly in conjunction with configuration of the storage system for at least one of a migration operation and a replication operation.

For example, a storage system may include first and second storage arrays, with data being migrated from the first storage array to the second storage array prior to removing the first storage array from the storage system.

As another example, a storage system may include a production storage array and a recovery storage array, with data being replicated from the production storage array to the recovery storage array so as to be available for data recovery in the event of a failure involving the production storage array.

In these and other situations, path discovery scans may be repeated as needed in order to discover the addition of new paths or the deletion of existing paths.

A given path discovery scan can be performed utilizing known functionality of conventional MPIO drivers, such as PowerPath® drivers.

The path discovery scan in some embodiments may be further configured to identify one or more new LUNs or other logical storage volumes associated with the one or more new paths identified in the path discovery scan. The path discovery scan may comprise, for example, one or more bus scans which are configured to discover the appearance of any new LUNs that have been added to the distributed storage system 102 as well to discover the disappearance of any existing LUNs that have been deleted from the distributed storage system 102.

The MPIO driver of the given host device in some embodiments comprises a user-space portion and a kernel-space portion. The kernel-space portion of the MPIO driver may be configured to detect one or more path changes of the type mentioned above, and to instruct the user-space portion of the MPIO driver to run a path discovery scan responsive to the detected path changes. Other divisions of functionality between the user-space portion and the kernel-space portion of the MPIO driver are possible. The user-space portion of the MPIO driver is illustratively associated with an Operating System (OS) kernel of the given host device.

For each of one or more new paths identified in the path discovery scan, the given host device may be configured to execute a host registration operation for that path. The host registration operation for a given new path illustratively provides notification to the distributed storage system 102 that the given host device has discovered the new path.

As indicated previously, the storage nodes 105 of the distributed storage system 102 process IO operations from one or more host devices 101 and in processing those IO operations run various storage application processes that generally involve interaction of that storage node with one or more other ones of the storage nodes.

In the FIG. 1 embodiment, the distributed storage system 102 comprises storage controllers 108 and corresponding sets of storage devices 106, and may include additional or alternative components, such as sets of local caches.

The storage controllers 108 illustratively control the processing of IO operations received in the distributed storage system 102 from the host devices 101. For example, the storage controllers 108 illustratively manage the processing of read and write commands directed by the MPIO drivers of the host devices 101 to particular ones of the storage devices 106. The storage controllers 108 can be implemented as respective storage processors, directors or other storage system components configured to control storage system operations relating to processing of IO operations. In some embodiments, each of the storage controllers 108 has a different one of the above-noted local caches associated therewith, although numerous alternative arrangements are possible.

As indicated previously, the storage nodes 105 collectively comprise an example of a distributed storage system. The term “distributed storage system” as used herein is intended to be broadly construed, so as to encompass, for example, scale-out storage systems, clustered storage systems or other types of storage systems distributed over multiple storage nodes.

As another example, the storage nodes 105 in some embodiments are part of a distributed content addressable storage system in which logical addresses of data pages are mapped to physical addresses of the data pages in the storage devices 106 using respective hash digests, hash handles or other content-based signatures that are generated from those data pages using a secure hashing algorithm. A wide variety of other types of distributed storage systems can be used in other embodiments.

Also, the term “storage volume” as used herein is intended to be broadly construed, and should not be viewed as being limited to any particular format or configuration.

In some embodiments, the storage nodes 105 are implemented using processing modules that are interconnected in a full mesh network, such that a process of one of the processing modules can communicate with processes of any of the other processing modules. Commands issued by the processes can include, for example, remote procedure calls (RPCs) directed to other ones of the processes.

The sets of processing modules of the storage nodes 105 illustratively comprise control modules, data modules, routing modules and at least one management module. Again, these and possibly other processing modules of the storage nodes 105 are illustratively interconnected with one another in the full mesh network, such that each of the modules can communicate with each of the other modules, although other types of networks and different module interconnection arrangements can be used in other embodiments.

The management module in such an embodiment may more particularly comprise a system-wide management module, also referred to herein as a system manager. Other embodiments can include multiple instances of the management module implemented on different ones of the storage nodes 105.

A wide variety of alternative configurations of nodes and processing modules are possible in other embodiments. Also, the term “storage node” as used herein is intended to be broadly construed, and may comprise a node that implements storage control functionality but does not necessarily incorporate storage devices. As mentioned previously, a given storage node can in some embodiments comprise a separate storage array, or a portion of a storage array that includes multiple such storage nodes.

Communication links may be established between the various processing modules of the storage nodes using well-known communication protocols such as TCP/IP and RDMA. For example, respective sets of IP links used in data transfer and corresponding messaging could be associated with respective different ones of the routing modules.

The storage nodes 105 of the distributed storage system 102 implement respective instance of node security reporting logic 110-1, 110-2 . . . 110-M (collectively, node security reporting logic 110). The node security reporting logic 110 provides, to the system management nodes 112 (e.g., the control plane servers 114 thereof implementing a control plane for the distributed storage system 102), node security information for the storage nodes 105. The node security information may include, but is not limited to, information on vulnerabilities or other security issues encountered on the storage nodes 105. The control plane servers 114 implement node security analysis logic 116, which is configured to analyze the reported node security information from the node security reporting logic 110 of the storage nodes 105. The node security analysis logic 116, on detecting that a given one of the storage nodes 105 has an “unhealthy” security status, the control plane servers 114 utilize the storage node deployment logic 118 to initiate one or more corrective or remedial measures for transitioning the given storage node 105 to a “healthy” security status. This may include, for example, applying one or more patches (if available) for vulnerabilities or other security issues encountered on the given storage node 105. If no patches are available or, more generally, if no corrective or remedial measures are available for transitioning the given storage node 105 from the unhealthy to the healthy security status, the storage node deployment logic 118 may deploy a new storage node in the distributed storage system, and migrate data from the given storage node 105 to the newly deployed storage node. The given storage node 105 may then be taken offline or otherwise removed from the distributed storage system 102 for further servicing.

The particular features described above in conjunction with FIG. 1 should not be construed as limiting in any way, and a wide variety of other system arrangements providing functionality for security management for endpoint nodes of distributed processing systems are possible.

The storage nodes 105 of the example distributed storage system 102 illustrated in FIG. 1 are assumed to be implemented using at least one processing platform, with each such processing platform comprising one or more processing devices, and each such processing device comprising a processor coupled to a memory. Such processing devices can illustratively include particular arrangements of compute, storage and network resources.

The storage nodes 105 may be implemented on respective distinct processing platforms, although numerous other arrangements are possible. At least portions of their associated host devices 101 may be implemented on the same processing platforms as the storage nodes 105 or on separate processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different subsets of the host devices 101 and the storage nodes 105 to reside in different data centers. Numerous other distributed implementations of the storage nodes 105 and their respective associated sets of host devices 101 are possible.

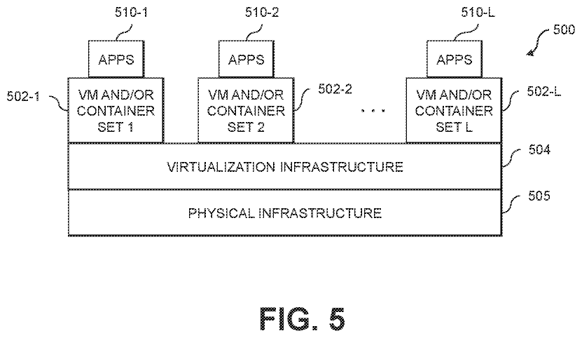

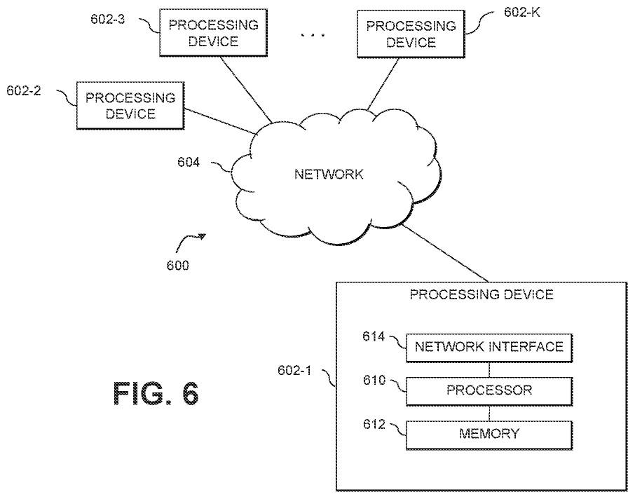

Additional examples of processing platforms utilized to implement storage systems and possibly their associated host devices in illustrative embodiments will be described in more detail below in conjunction with FIGS. 5 and 6.

It is to be appreciated that these and other features of illustrative embodiments are presented by way of example only, and should not be construed as limiting in any way.

Accordingly, different numbers, types and arrangements of system components such as host devices 101, distributed storage system 102, storage nodes 105, storage devices 106, storage controllers 108, system management nodes 112 and instances of node security reporting logic 110, node security analysis logic 116 and storage node deployment logic 118 can be used in other embodiments. For example, as mentioned previously, system management functionality of the system management nodes 112 can be distributed across a subset of the storage nodes 105, instead of being implemented on separate nodes.

It should be understood that the particular sets of modules and other components implemented in a distributed storage system as illustrated in FIG. 1 are presented by way of example only. In other embodiments, only subsets of these components, or additional or alternative sets of components, may be used, and such components may exhibit alternative functionality and configurations.

For example, in some embodiments, certain portions of the functionality for security management for endpoint nodes of distributed processing systems as disclosed herein may be implemented through cooperative interaction of one or more host devices, one or more storage nodes of a distributed storage system, and/or one or more system management nodes. Accordingly, such functionality can be distributed over multiple distinct processing devices. The term “at least one processing device” as used herein is therefore intended to be broadly construed.

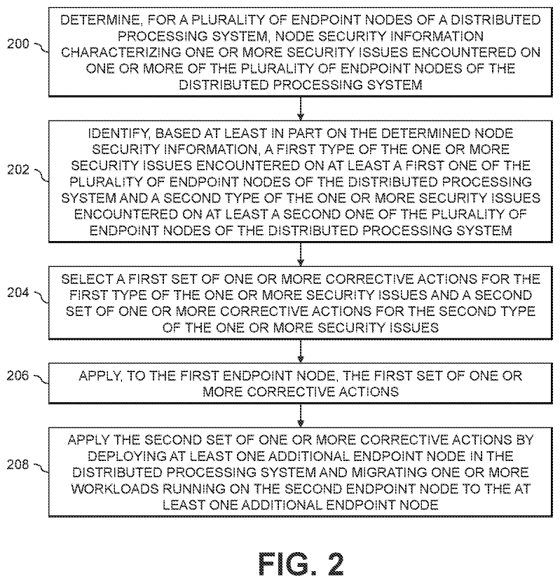

The operation of the information processing system 100 will now be described in further detail with reference to the flow diagram of the illustrative embodiment of FIG. 2, which illustrates a process for implementing security management for endpoint nodes of distributed processing systems utilizing the node security reporting logic 110, the node security analysis logic 116 and the storage node deployment logic 118. This process may be viewed as an illustrative example of an algorithm implemented at least in part by one or more of the storage nodes 105 and/or one or more of the system management nodes 112 utilizing corresponding instances of the node security reporting logic 110, the node security analysis logic 116, and the storage node deployment logic 118. These and other algorithms for security management for endpoint nodes of distributed processing systems as disclosed herein can be implemented using other types and arrangements of system components in other embodiments.

The process illustrated in FIG. 2 includes steps 200 through 208. In step 200, node security information characterizing one or more security issues encountered on one or more of a plurality of endpoint nodes of a distributed processing system are determined. In step 202, a first type of the one or more security issues encountered on at least a first one of the plurality of endpoint nodes of the distributed processing system and a second type of the one or more security issues encountered on at least a second one of the plurality of endpoint nodes of the distributed processing system are identified based at least in part on the determined node security information. A first set of one or more corrective actions for the first type of the one or more security issues and a second set of one or more corrective actions for the second type of the one or more security issues are selected in step 204. In some embodiments, the first type of the one or more security issues may comprise security vulnerabilities associated with one or more patches, and the second type of the one or more security issues may comprise security vulnerabilities for which there are no patches available. The first type of the one or more security issues may comprise security vulnerabilities associated with at least a designated threshold criticality. In other embodiments, the first type of the one or more security issues may comprise security vulnerabilities associated with a first criticality level and the second type of the one or more security issues may comprise security vulnerabilities associated with a second criticality level, the second criticality level being different than the first criticality level. The second type of the one or more security issues may comprise security vulnerabilities which are rooted in one or more designated components of the second endpoint node. The one or more designated components comprise an operating system architecture of the second endpoint node. The first set of one or more corrective actions may be applied non-disruptively to the first endpoint node without affecting at least one workload running on the first endpoint node.

The first set of one or more corrective actions are applied to the first endpoint node in step 206. The second set of one or more corrective actions are applied in step 208 by deploying at least one additional endpoint node in the distributed processing system and migrating one or more workloads running on the second endpoint node to the at least one additional endpoint node. Applying the second set of one or more corrective actions in step 208 may further comprise, responsive to a successful migration of the one or more workloads running on the second endpoint node to the at least one additional endpoint node, removing the second endpoint node from the distributed processing system.

In some embodiments, the FIG. 2 process is performed by a processing device which comprises at least a portion of a control plane of the distributed processing system configured for communication with the plurality of endpoint nodes of the distributed processing system over one or more networks. At least a portion of the control plane may be implemented in a distributed manner across two or more of the plurality of endpoint nodes of the distributed processing system.

The distributed processing system may comprise a software-defined storage system, and the plurality of endpoint nodes may comprise respective software-defined storage server nodes of the software-defined storage system. Migrating the one or more workloads may comprise migrating data stored on the second endpoint node to the at least one additional endpoint node.

The distributed processing system may comprise a cloud-based processing system, and the plurality of endpoint nodes may comprise respective cloud endpoint nodes operating on one or more clouds of one or more cloud service providers.

The steps of the FIG. 2 process are shown in sequential order for clarity and simplicity of illustration only, and certain steps can at least partially overlap with other steps. Additional or alternative steps can be used in other embodiments.

The particular processing operations and other system functionality described in conjunction with the flow diagram of FIG. 2 are presented by way of illustrative example only, and should not be construed as limiting the scope of the disclosure in any way. Alternative embodiments can use other types of processing operations for implementing security management for endpoint nodes of distributed processing systems. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different security management processes for respective different distributed processing systems, or for a different set of endpoints nodes of a same distributed processing system.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Host devices, storage nodes and system management nodes can be implemented as part of what is more generally referred to herein as a processing platform comprising one or more processing devices each comprising a processor coupled to a memory.

A given such processing device in some embodiments may correspond to one or more virtual machines or other types of virtualization infrastructure such as Docker containers or Linux containers (LXCs). Host devices, storage nodes, system management nodes and other system components may be implemented at least in part using processing devices of such processing platforms. For example, respective path selection logic instances and other related logic instances of the host devices can be implemented in respective containers running on respective ones of the processing devices of a processing platform.

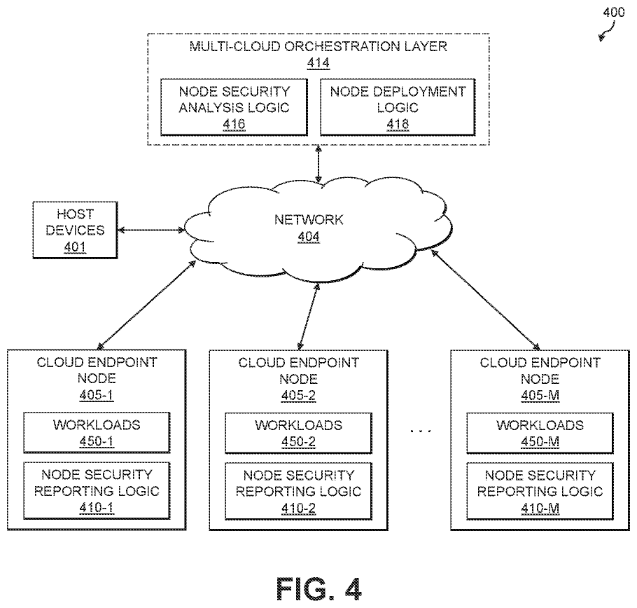

Additional examples of illustrative embodiments will now be described with reference to FIGS. 3 and 4. These embodiments illustrate other examples of distributed systems. More particularly, FIG. 3 shows an example of a distributed storage system that comprises a software-defined storage system having a plurality of software-defined storage server nodes, also referred to as SDS server nodes. Such SDS server nodes are examples of “storage nodes” as that term is broadly used herein. As will be appreciated by those skilled in the art, similar embodiments can be implemented without the use of software-defined storage and with other storage access protocols. FIG. 4 shows an example of a multi-cloud distributed system having a plurality of cloud endpoint nodes.

Illustrative embodiments provide technical solutions which enable cyber resilience on multiple endpoint nodes (e.g., storage and/or compute nodes, including but not limited to cloud endpoint devices, SDS server nodes, data protection endpoint products, etc.) via an orchestration layer (e.g., a control plane of a distributed storage and/or compute system, including but not limited to a multi-cloud orchestration layer, a SDS system control plane, etc.). The orchestration layer enables automated deployment of the endpoint nodes, as well as the ability to perform various remedial or corrective actions on endpoints which are currently deployed. The orchestration layer can advantageously provide cloud or other system-agnostic toolsets for performing various tasks, including software development and operations (DevOps), IT operations tasks, etc.

For cloud and other distributed computing and/or storage systems, applications may continue to service on endpoint nodes even if the endpoint nodes have critical security vulnerabilities reported thereon. In conventional approaches, failover or corrective actions are triggered only based on the physical health of the endpoint nodes. Health issues related to security, even if monitored for, are only flagged. Other than default operating system (OS)-specific vulnerabilities, endpoint nodes may be affected with security vulnerabilities caused by customer-deployed tools or applications running on the endpoint nodes. In some cases, such security vulnerabilities are critical vulnerabilities which can affect endpoint node performance. Typically, vulnerabilities are only flagged as critical, high, medium, or low. No corrective actions are performed dynamically, and unattended vulnerabilities can lead to service disruption and data breaches. In conventional approaches, manual interference is required to address challenges like fixing vulnerable endpoint nodes by applying patches, replacing affected endpoint nodes, etc.

The technical solutions described herein provide various technical advantages for achieving cyber resiliency in multi-cloud platforms and other distributed computing and/or storage systems. Critical security alerts may be a key factor for endpoint health screening. On detecting critical vulnerabilities, some embodiments orchestrate new vulnerability-free endpoint node deployments dynamically (e.g., for deeply rooted vulnerabilities, for vulnerabilities with no available patches or only unverified patches available, etc.). The technical solutions are therefore able to seamlessly eliminate “concerning” endpoint nodes (e.g., those with reported security vulnerabilities or other issues) with minimal impact. In addition to considering single-node security factors, the technical solutions can also take into account and address inter-node security factors (e.g., inter-node health impacting attributes). Advantageously, the technical solutions described herein are able to ensure the health of endpoint nodes in a distributed computing and/or storage system (e.g., software-define cloud storage endpoints of a SDS system) by consuming and evaluating security health information for all participating endpoint nodes. Critical security alerts and other single-node and inter-node security factors are used for endpoint health screening to trigger corrective actions. Such corrective actions may be taken non-disruptively using an orchestration layer.

FIG. 3 shows an information processing system 300 comprising one or more host devices 301 configured to communicate over a network 304, illustratively a TCP/IP network, with a software-defined storage system comprising a plurality of SDS server nodes 305-1, 305-2 . . . 305-M and corresponding SDS control plane servers 314. The SDS control plane servers 314 are shown in dashed outline as the functionality of such servers in illustrative embodiments is distributed over a particular subset of the SDS server nodes 305 rather than being implemented on separate nodes of the SDS system. The SDS control plane servers 314 provide system management functionality such as centralized storage provisioning, monitoring, membership management, as well as storage partitioning.

A plurality of applications execute on the host devices 301 and generate IO operations that are delivered to particular ones of the SDS server nodes 305, represented as the workloads 350-1, 350-2 . . . 350-M (collectively, workloads 350) running on the SDS server nodes 305. In some embodiments, the SDS server nodes 305 are configured at least in part as respective PowerFlex® software-defined storage nodes from Dell Technologies, suitably modified as disclosed herein, although other types of storage nodes can be used in other embodiments.

The SDS control plane servers 314 provide an orchestration layer which enables cyber resilience on the SDS server nodes 305. In some embodiments, the workloads 350 running on the SDS server nodes introduce security vulnerabilities or other issues. The SDS server nodes 305-1, 305-2, . . . 305-M implement respective instances of node security reporting logic 310-1, 310-2, . . . 310-M (collectively, node security reporting logic 310) which reports node health information (e.g., vulnerabilities or other security issues encountered on the SDS server nodes 305, possibly as a result of the workloads 350 running thereon) to the SDS control plane servers 314.

The SDS control plane servers 314 implement node security analysis logic 316 and node deployment logic 318. The node security analysis logic 316 is configured to analyze the node health information reported by the SDS server nodes 305 via the node security reporting logic 310. The node security analysis logic 316, based on the analysis, determines whether one or more corrective or remediation actions should be performed based on the node health status of the SDS server nodes 305. Such corrective or remediation actions, for example, may include applying patches for vulnerabilities encountered on the SDS server nodes 305, applying security hardening procedures to the SDS server nodes 305 to reduce or mitigate the potential effects of the encountered vulnerabilities, etc. In some cases, such as where no patches or other fixes are available or where vulnerabilities or other security issues are deeply rooted in one or more of the SDS server nodes 305, the corrective or remediation actions may include utilizing the node deployment logic 318 to deploy additional SDS server nodes, migrate workloads on affected ones of the SDS server nodes 305 to the deployed additional SDS server nodes. The affected ones of the SDS server nodes 305 may then be taken offline or otherwise removed from the SDS system for further processing (e.g., re-configuration to remove the deeply rooted vulnerabilities or other security issues).

FIG. 4 shows a system 400 including a multi-cloud orchestration layer 414 which manages a set of cloud endpoint nodes 405-1, 405-2 . . . 405-M (collectively, cloud endpoint nodes 405). The multi-cloud orchestration layer 414 and the cloud endpoint nodes 405 communicate over network 404. The multi-cloud orchestration layer 414 is shown in dashed outline as the functionality of the multi-cloud orchestration layer 414 may be distributed over at least a subset of the cloud endpoint nodes 405 rather than being implemented on separate servers or other nodes. In some embodiments, different ones of the cloud endpoint nodes 405 run on different clouds of one or more different cloud service providers. The cloud endpoints nodes 405-1, 405-2 . . . 405-M run workloads 450-1, 450-2 . . . 450-M (collectively, workloads 450) on behalf of one or more requesting host devices 401. Such workloads 450 may introduce security vulnerabilities or other security issues on the cloud endpoint nodes 405. The cloud endpoint nodes 405-1, 405-2 . . . 405-M implement respective instances of node security reporting logic 410-1, 410-2 . . . 410-M (collectively, node security reporting logic 410) which reports node health information (e.g., vulnerabilities or other security issues encountered on the cloud endpoint nodes 405, which may in some cases be a result of running the workloads 450) to the multi-cloud orchestration layer 414.

The multi-cloud orchestration layer 414 implements node security analysis logic 416 and node deployment logic 418. The node security analysis logic 416 is configured to analyze the node health information reported by the cloud endpoint nodes 405 via the node security reporting logic 410. The node security analysis logic 416, based on the analysis, determines whether one or more corrective or remediation actions should be performed based on the node health status of the cloud endpoint nodes 405. The corrective or remediation actions, for example, may include applying patches or other fixes for critical vulnerabilities on the cloud endpoint nodes 405. In some cases, such as where the critical vulnerabilities are deeply rooted on the cloud endpoint nodes 405 or where there is no patch available, the node security analysis logic 416 may utilize the node deployment logic 418 to deploy one or more additional cloud endpoint nodes to replace the affected cloud endpoint nodes 405. As part of this deployment, ones of the workloads 450 running on the affected cloud endpoint nodes 405 may be moved to the newly deployed additional cloud endpoint nodes.

The multi-cloud orchestration layer 414 is configured to utilize the node security analysis logic 416 to perform security assessments of the cloud endpoint nodes 405 (e.g., at regular intervals, based on information reported via the node security reporting logic 410). On cloud endpoint nodes 405 with identified critical vulnerabilities, the multi-cloud orchestration layer 414 uses the node deployment logic 418 to act on the gained information by triggering remediation plans such as applying patch updates to the cloud endpoint nodes 405. For situations where the vulnerabilities are deeply rooted (e.g., in an OS architecture of OSes running on the cloud endpoint nodes 405), or where the vulnerabilities have no patches, the node deployment logic 418 may trigger deployment of new cloud endpoint nodes 405 as per an organization's security guidelines. The cloud endpoint nodes 405 may have maintenance procedures that can be followed for bringing in newer cloud endpoint nodes into a cluster seamlessly. Any data from vulnerable ones of the cloud endpoint nodes 405 (e.g., workloads 450) may be migrated to the newly-deployed cloud endpoint nodes. The vulnerable ones of the cloud endpoint nodes 405 can be gracefully evicted from the cluster post migration of the workloads 450 running on the vulnerable ones of the cloud endpoint nodes 405. Similarly, participating ones of the cloud endpoint nodes 405 identified as vulnerable may be refreshed automatically. Thus, illustrative embodiments provide various advantages relative to conventional approaches where cloud endpoint nodes continue service of workloads even when reporting critical vulnerabilities, and where administrators have to manually identify the affected cloud endpoint nodes and perform maintenance activity as per scheduled maintenance.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to provide functionality for security management for endpoint nodes of distributed processing systems will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100. The cloud infrastructure 500 comprises multiple virtual machines (VMs) and/or container sets 502-1, 502-2 . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2 . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. Such implementations can provide host-based locality determination functionality in a distributed storage system of the type described above using one or more processes running on a given one of the VMs. For example, each of the VMs can implement logic instances and/or other components for implementing functionality associated with host-based locality determination and associated path selection in the system 100.

A hypervisor platform may be used to implement a hypervisor within the virtualization infrastructure 504. Such a hypervisor platform may comprise an associated virtual infrastructure management system. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system. Such implementations can also provide host-based locality determination functionality in a distributed storage system of the type described above. For example, a container host device supporting multiple containers of one or more container sets can implement logic instances and/or other components for implementing functionality associated with host-based locality determination and associated path selection in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), graphics processing unit (GPU) or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for security management for endpoint nodes of distributed processing systems as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, host devices, storage systems, storage nodes, storage devices, storage controllers, and other components. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to determine, for a plurality of endpoint nodes of a distributed processing system, node security information characterizing one or more security issues encountered on one or more of the plurality of endpoint nodes of the distributed processing system;
to identify, based at least in part on the determined node security information, a first type of the one or more security issues encountered on at least a first one of the plurality of endpoint nodes of the distributed processing system and a second type of the one or more security issues encountered on at least a second one of the plurality of endpoint nodes of the distributed processing system;
to select a first set of one or more corrective actions for the first type of the one or more security issues and a second set of one or more corrective actions for the second type of the one or more security issues;
to apply, to the first endpoint node, the first set of one or more corrective actions; and
to apply the second set of one or more corrective actions by deploying at least one additional endpoint node in the distributed processing system and migrating one or more workloads running on the second endpoint node to the at least one additional endpoint node.

2. The apparatus of claim 1 wherein the at least one processing device comprises at least a portion of a control plane of the distributed processing system configured for communication with the plurality of endpoint nodes of the distributed processing system over one or more networks.

3. The apparatus of claim 2 wherein at least a portion of the control plane is implemented in a distributed manner across two or more of the plurality of endpoint nodes of the distributed processing system.

4. The apparatus of claim 1 wherein the distributed processing system comprises a software-defined storage system, and wherein the plurality of endpoint nodes comprise respective software-defined storage server nodes of the software-defined storage system.

5. The apparatus of claim 4 wherein migrating the one or more workloads comprises migrating data stored on the second endpoint node to the at least one additional endpoint node.

6. The apparatus of claim 1 wherein the distributed processing system comprises a cloud-based processing system, and wherein the plurality of endpoint nodes comprise respective cloud endpoint nodes operating on one or more clouds of one or more cloud service providers.

7. The apparatus of claim 1 wherein applying the second set of one or more corrective actions further comprises, responsive to a successful migration of the one or more workloads running on the second endpoint node to the at least one additional endpoint node, removing the second endpoint node from the distributed processing system.

8. The apparatus of claim 1 wherein the first type of the one or more security issues comprise security vulnerabilities associated with one or more patches.

9. The apparatus of claim 1 wherein the first type of the one or more security issues comprise security vulnerabilities associated with at least a designated threshold criticality.

10. The apparatus of claim 1 wherein the second type of the one or more security issues comprise security vulnerabilities for which there are no patches available.

11. The apparatus of claim 1 wherein the first type of the one or more security issues comprise security vulnerabilities associated with a first criticality level and the second type of the one or more security issues comprise security vulnerabilities associated with a second criticality level, the second criticality level being different than the first criticality level.

12. The apparatus of claim 1 wherein the second type of the one or more security issues comprise security vulnerabilities which are rooted in one or more designated components of the second endpoint node.

13. The apparatus of claim 12 wherein the one or more designated components comprise an operating system architecture of the second endpoint node.

14. The apparatus of claim 1 wherein the first set of one or more corrective actions are applied non-disruptively to the first endpoint node without affecting at least one workload running on the first endpoint node.

15. A computer program product comprising a non-transitory processor-readable storage medium having stored therein program code of one or more software programs, wherein the program code when executed by at least one processing device comprising a processor coupled to a memory, causes the at least one processing device:
to determine, for a plurality of endpoint nodes of a distributed processing system, node security information characterizing one or more security issues encountered on one or more of the plurality of endpoint nodes of the distributed processing system;
to identify, based at least in part on the determined node security information, a first type of the one or more security issues encountered on at least a first one of the plurality of endpoint nodes of the distributed processing system and a second type of the one or more security issues encountered on at least a second one of the plurality of endpoint nodes of the distributed processing system;
to select a first set of one or more corrective actions for the first type of the one or more security issues and a second set of one or more corrective actions for the second type of the one or more security issues;
to apply, to the first endpoint node, the first set of one or more corrective actions; and
to apply the second set of one or more corrective actions by deploying at least one additional endpoint node in the distributed processing system and migrating one or more workloads running on the second endpoint node to the at least one additional endpoint node.

16. The computer program product of claim 15 wherein the distributed processing system comprises a software-defined storage system, and wherein the plurality of endpoint nodes comprise respective software-defined storage server nodes of the software-defined storage system.

17. The computer program product of claim 15 wherein the distributed processing system comprises a cloud-based processing system, and wherein the plurality of endpoint nodes comprise respective cloud endpoint nodes operating on one or more clouds of one or more cloud service providers.

18. A method comprising:
determining, for a plurality of endpoint nodes of a distributed processing system, node security information characterizing one or more security issues encountered on one or more of the plurality of endpoint nodes of the distributed processing system;
identifying, based at least in part on the determined node security information, a first type of the one or more security issues encountered on at least a first one of the plurality of endpoint nodes of the distributed processing system and a second type of the one or more security issues encountered on at least a second one of the plurality of endpoint nodes of the distributed processing system;
selecting a first set of one or more corrective actions for the first type of the one or more security issues and a second set of one or more corrective actions for the second type of the one or more security issues;
applying, to the first endpoint node, the first set of one or more corrective actions; and
applying the second set of one or more corrective actions by deploying at least one additional endpoint node in the distributed processing system and migrating one or more workloads running on the second endpoint node to the at least one additional endpoint node;
wherein the method is performed by at least one processing device comprising a processor coupled to a memory.

19. The method of claim 18 wherein the distributed processing system comprises a software-defined storage system, and wherein the plurality of endpoint nodes comprise respective software-defined storage server nodes of the software-defined storage system.

20. The method of claim 18 wherein the distributed processing system comprises a cloud-based processing system, and wherein the plurality of endpoint nodes comprise respective cloud endpoint nodes operating on one or more clouds of one or more cloud service providers.
